(19) United States
(12) Patent Application Publication
(10) Pub. No.: US 2011/0088580 A1
(43) Pub. Date: Apr. 21, 2011

(54) System and Method for Producing a High Surface Friction Material with at Least One Predetermined Graphical Image Embedded Therein

(75) Inventor: Jon Stuart, Tenafly, NJ (US)

(73) Assignee: SJ PATENT HOLDING LLC, North Bergen, NJ (US)

(21) Appl. No.: 12/906,004

(22) Filed: Oct. 15, 2010

Related U.S. Application Data
(60) Provisional application No. 61/252,147, filed on Oct. 15, 2009.

(51) Int. Cl. B41F 33/00

(52) U.S. Cl. 101/483

(57) ABSTRACT

The system and method implement a production process that involves embedding one or more predetermined pre-selected graphical images into an image transfer receptive target layer of the novel HSF material that is positioned below at least one image transfer compliant HSF surface layer(s). An alternate embodiment of the present invention provides a system and method, implementable in a self-contained configuration (e.g., kiosk, vending machine, etc.), and/or implementable as an e-commerce platform over a communication network (e.g., as an Internet-based e-Commerce service), that enables each user to purchase, and/or to order, various pre-made or custom-produced inventive HSF material products (e.g., in grip tape form, etc.), having one or more user-selected and/or user-provided graphical images embedded therein.

### CROSS REFERENCE TO RELATED APPLICATIONS

The present patent application claims priority from the commonly assigned co-pending U.S. provisional patent application 61/252,147 entitled “System and Method for Producing a High Surface Friction Material with at Least One Predetermined Graphical Image Embedded Therein”, filed Oct. 15, 2009.

### FIELD OF THE INVENTION

The present invention relates generally to high surface friction materials incorporating at least one graphical image, and more particularly to systems and methods for producing high surface friction materials having one or more predetermined user-selected graphical images embedded therein during the production process.

### BACKGROUND OF THE INVENTION

High surface friction (“HSF”) materials are in widespread use in consumer, commercial, and industrial applications, most typically employed to provide non-slip/non-skid/improved traction properties to flooring and stair surfaces, to vehicles (especially to marine vehicles), and to sports activity equipment, and the like (e.g., to skateboards, snowboards, surfboards, etc.). In certain configurations (e.g., adhesive-backed tape, etc.), small scale HSF materials may also be used for hand-held equipment (or equipment components) to provide improved grip properties (for example for tennis rackets, hockey sticks, baseball bat handles, and even for bicycle/motorcycle handles). Of course, HSF materials offer many additional solutions and benefits in a wide variety of miscellaneous applications where their properties are necessary and/or useful, such as in toys (e.g., in the popular “fingerboards”—miniaturized skateboard replicas), in footwear (e.g., for outer soles), and, in certain configurations, even as abrasive surfaces.

While, as is noted above, HSF materials of many different types are offered in a wide variety of form factors and configurations, most HSF materials may be split into three broad categories:
(Category-1): Direct target surface application in which the HSF material is intended for long-term use, and/or for wide-area coverage, and is thus applied (e.g., pressure sprayed, rolled onto, etc.) directly onto the intended recipient surface (such as onto a floor, stairs, walkway, etc.) through one or more special techniques, and is then typically cured, and/or sealed, to improve resilience or strength, etc.).
   Typical configurations/compositions of Category-1 HSF materials comprise a fluid with dispersed abrasive (or equivalent) particles or elements suspended therein, that is capable of being hardened or cured when applied to the intended surface (e.g., through a high pressure stream, or through other form of surface deposition) either on its own (e.g., following exposure to air), by application of certain curing technique(s) thereto, and/or in response to one or more other materials being applied thereto. Category-1 HSF materials may also include or accept one or more protective surface coating(s) after application thereof to the intended surface;
(Category-2): Modular/Intermediary surface application in which the HSF material is applied in at least one of the following schemes: (a) to an intermediary, and/or modular, surface, such as to a panel, tile, mat, rug, etc., which is then mounted in its intended location (e.g., covering another surface over which HSF properties are needed), and/or (b) to a vehicle/device component (e.g., running board, skateboard body, etc.), which is then mounted on, or connected to, other vehicle device components to provide one or more regions thereon (and/or therein), with HSF properties.
   Typical configurations/compositions of Category-2 HSF materials include multi-layered components (e.g., flat layered panels or tiles, vehicle or device sub-components with layered surface regions, etc.), most commonly comprising a main “substrate” layer, serving as the main platform for other functional layers, and providing the desired shape, size and structural integrity to the HSF material component, with various functional layers applied to one or both sides of the substrate: for example a bonding (e.g., adhesion), or bonding-ready, layer on the underside for attachment of the component to other surfaces, a high surface friction (e.g., abrasive surface) layer (e.g., such as a polymer, resinous, or other resilient substance impregnated with grit material or equivalent), applied to the outer surface of the substrate (with an optional intermediary layer therebetween (e.g., for improved bonding, resilience, etc.)) that provides the desired HSF properties to the component; and
(Category-3): Selective/Versatile application in which the HSF material is implemented in a versatile selective deployment platform, such as in form of adhesive-backed “grip” tape, and/or in form of grip sheets (which may be pre-cut in a variety of standardized sizes, cut to size, die-stamped, etc.) which are also commonly backed with an adhesive coating backed with protective removable sheeting. This is one of the most popular categories of HSF materials due to the inherent scalability and versatility of self-adhesive tape, and/or of sheet-based configurations, that may be easily and selectively utilized, in a broad spectrum of applications from flooring, to vehicles, to equipment, etc., and that may also be readily used in Category-1 and Category-2 HSF material applications. For example, the most popular Category-3 HSF material configuration, is the self-adhesive “grip tape” format, available in a wide variety of product sizes, resilience levels, friction strengths, colors, etc. The tape format is very easy to use in such quantities, and at such locations as may be selected by the user, for any application ranging from skateboard surfaces, to stair steps, flooring, vehicle sections (boats, running boards, etc.), and even for covering grip regions of handheld equipment.
   Typical configuration/compositions of Category-3 HSF materials include a multi-layered, preferably flexible, component (e.g., tape capable for being deployed in a roll, a wide roll, a flat sheet, etc.), most commonly comprising a main flexible “substrate” layer (such as vinyl, acrylic, synthetic webbing, thickened polymer film, etc.), serving as the main platform or structural support for other functional layers.

For many years, HSF materials of all three categories (and especially of the Categories-2 and -3) were only available in a very limited palette of colors, most typically black and gray (e.g., charcoal gray), simply as a factor of the colors or properties of the various material layers used in the HSF material product composition. Over time, additional color options were introduced for certain HSF material products for functional reasons, such as white, bright red, yellow, striped yellow/black colors for safety and for ease of visual identification of surfaces on which HSF materials were deployed.

The need for additional color options grew with increased use of Category-3 HSF materials, especially in sports or recreational activities applications, when users began to employ HSF materials such as grip tape, etc., in different and/or multiple colors for additional purposes of equipment decoration or personalization. As individuals began to combine and use HSF material component elements of different colors to create functional HSF material designs, it was clear that better solutions for providing decorative or aesthetically pleasing HSF material products were needed.

Initially, many attempted to simply paint various designs/graphics/images on the desired surfaces of target objects—an approach that succeeded in producing attractive display/art objects, but that was obviously flawed when applied to objects that were in actual use, because, due to the variable surface morphology of the HSF material covering the exposed outer object surfaces, and in view of resilient composition thereof, any paint applied thereto quickly wore off during repeated use, rapidly damaging, and eventually destroying, the painted designs.

Not satisfied with manually cutting out, assembling, and then applying crude designs from multiple grip tape pieces of various colors to their skateboard tops (which enabled crude but relatively wear-resistant and functional decorative designs), users clamored for products or techniques that would enable them to maximize the available options and possible ranges of artistic expression, and in other activities in which aesthetics and design could be combined with HSF functionality, and, at the same time, survive actual HSF material-equipped product use.

Over the years, many attempts have been made to address the above needs, and to meet the challenges of “combining art with function” in skateboarding, and in various other HSF material applications. For example, over the years, various techniques below were attempted or utilized either individually, and/or in different combinations. However, each previously known approach suffers from significant disadvantages that could not be fully addressed, even by combinations thereof with other techniques:
Direct-to-surface image application techniques have been employed to apply colors, designs, and images directly to Category-2 HSF materials, such as by airbrushing or spray painting the HSF material surfaces with specially composed resilient paints directly, and in some cases onto specially prepared (e.g., primed) HSF material surfaces.
   Disadvantages: labor intensive and time consuming (especially when multiple colors are utilized, because only one color can be applied at a time, and drying time is often needed between applications), and therefore expensive, very difficult to mass produce with sufficient quality, typically only suitable for Category-2 HSF material applications, paint is still vulnerable to damage from active use of the HSF material surface;
Silk-screening techniques were also used for both Category-2 HSF material applications, and, in certain cases, also for Category-1 HSF material solutions (e.g., for grip tape, etc.).
   Disadvantages: while silk-screened HSF surfaces are more resistant to wear that conventionally painted surfaces, the silk screening process is complex, time consuming and limited in artistic complexity and scope—for example a separate unique screen is needed each time a different color is applied to the HSF material surface.
Multi-step techniques—these processes utilize a multi-step approach that involves first imprinting a desired image onto a vinyl substrate (most commonly with adhesive backing), and then application (i.e., by gluing, or otherwise securing) “clear” grip tape over the vinyl surface, covering and protecting the image, while ostensibly enabling the image to be viewed therethrough. This solution could be combined with one or both of the above—i.e., by spray painting, and/or silk-screening, one, or both, of the vinyl and/or of the clear grip tape surfaces.
   Disadvantages: while more resilient and less labor-intensive than the above-mentioned techniques, especially for complex images, the imaged vinyl or grip tape combination still suffers from a key disadvantage—by its very nature, even “clear” grip tape is never really transparent, and it thus obscures, and washes out, the imaged vinyl surface, decreasing the aesthetic value of the product, and may also damage or distort the image when applied to the vinyl surface, depending on the bonding technique used. Furthermore, the necessity of using vinyl as the substrate and image target, results in a relatively thick and unwieldy HSF material component. Finally, the multilayer configuration may be prone to layer separation under certain circumstances, especially during aggressive or repeated use of the HSF tape-covered imaged vinyl surface.

As is clearly evident from the above analysis of attempted or previously known solutions, no individual solution, nor any combination of multiple solutions, achieves the sought after goal of applying images to HSF materials in a cost-effective manner without compromising HSF material functionality, and also without suffering rapid image degradation during HSF material, component use. Rather, all previously known techniques were relatively costly, relatively time consuming and labor intensive, and, most importantly, required sacrifices in image quality to improve the resistance to image damage or wear, or required acceptance of image fragility and susceptibility to wear in exchange for higher degrees of image quality or visual impact. In addition, most of the above-described techniques did not allow for rapid production of custom HSF surfaced products utilizing custom images—spray painting is very expensive and time consuming, while silk-screening requires expensive preparations for each color of a new image.

One technique, disclosed in U.S. Pat. No. 4,911,734, of William C. Short, entitled “Process for making printed abrasive sheets” (hereinafter referred to as the “734 patent”). The '734 patent disclosed an abrasive sheet having a design printed thereon, and also taught a process for making such sheets using a sublimation heat transfer printing process (see '734 patent, Column 1, lines 39-40). Under this technique, a design is printed onto an abrasive sheet having an abrasive side by contacting the abrasive side with a sublimation ink transfer sheet at a temperature, and for a time, sufficient to transfer the sublimation ink from the transfer sheet to the abrasive sheet (see '734 patent, Column 3, lines 40-47).

However, the process taught in the '734 patent does not appear to function in practice. Specifically, teachings of the '734 patent are clearly directed to utilization of “abrasive sheets known in the art” in its printing process (see '734 patent, Column 1, lines 59-68, and Column 2, lines 2 to 5), during which, the designs (e.g., images) are sublimated onto the sheets' abrasive surface (for example comprising a polymeric binder containing abrasive granules—see '734 patent, Column 2, lines 1 to 14). But, as is well known to, ones skilled in the art, the outer abrasive layers of virtually all commercially available “abrasive sheets”, including the specific brand name abrasive sheets disclosed by the '734 patent for use with the preferred embodiment of the process taught therein (see '734 patent, Column 1, lines 62-67, and Column 3, lines 38 to 41), utilize polymeric binders (and coatings thereon) that have melting points far below the bottom range of the temperatures required for any sublimation process, to lower the complexity and manufacturing and material expenses of such products. Accordingly, subjecting such commonly available abrasive sheets, as disclosed by the '743 patent, to conventional sublimation processes, would result in the abrasive sheet polymeric binder layer (or equivalent) melting before sublimation can take place, essentially causing the sublimation dyes or inks to bleed or disperse from the sublimation transfer or backing sheet into the melted polymeric binder, without forming the desired printed image therein.

Finally, even if an abrasive sheet having a polymeric binder with abrasive granules (or equivalent), that has been configured to withstand sublimation temperatures, ultimately, under the '734 patent technique, the image would still be printed or sublimated onto the exposed, granular outer surface of the HSF material component (e.g., the “abrasive sheet”) (see '734 patent, Column 1, lines 42-43). Accordingly, even if a HSF material component having an image deposited thereon by way of the '734 patent technique is somehow produced, is still very limited in the achievable level of quality or visual impact due to the image being deposited onto a textured or granular or abrasive material, and is still susceptible to surface wear and progressive deterioration resulting from active use of the HSF material component.

It would thus be desirable to provide a system and method for producing a high surface friction material having at least one image embedded therein, that optimize the quality and visual impact of the embedded image(s), while fully protecting the image(s) from damage and deterioration due to utilization of the host high surface friction material component. It would also thus be desirable to provide a system and method for producing a high surface friction material having at least one image embedded therein, that are scalable and configurable for use in fabrication of applied high friction surfaces, and for fabrication of various high surface friction material deployment platforms (e.g., tape, sheeting, etc.). It would further be desirable to provide a system and method for producing a high surface friction material having at least one image embedded therein, that are readily scalable for both customized, and for mass production. It would moreover be desirable to provide a system and method, implementable in a self-contained production/dispensing configuration, and/or implementable as an e-commerce platform over a communication network (e.g., as an Internet-based e-Commerce service), that enables users to purchase, and/or to order, various pre-made and/or custom—produced inventive high surface friction material products (e.g., in grip tape form, etc.), having one or more user-selected, and/or user-provided, graphical images embedded therein.

### BRIEF DESCRIPTION OF THE DRAWINGS

In the drawings, wherein like reference characters denote corresponding or similar elements throughout the various figures:

FIG. 1 shows a process flow diagram of a first exemplary embodiment of the inventive process for producing high surface friction (HSF) media with at least one image embedded therein (hereinafter “HSF/EI media”);

FIG. 2A shows a process flow diagram of a first exemplary embodiment of a portion of the inventive process of FIG. 1, relating to steps for providing image transfer optimized HSF media for use therewith;

FIG. 2B shows a process flow diagram of a second exemplary embodiment of a portion of the inventive process of FIG. 1, relating to steps for providing image transfer optimized HSF media for use therewith;

FIG. 3 shows a process flow diagram of an exemplary alternate embodiment of an inventive process step shown in each of FIGS. 2A and 2B, relating to application of an image transfer compliant (ITC) material layer having HSF properties to the top surface of an image transfer receptive (ITR) substrate;

FIG. 4 shows a process flow diagram of an exemplary embodiment of a portion of the inventive process of FIG. 1, relating to steps for conducting an image transfer process in accordance with an image transfer protocol, to embed a desired image in an ITR target layer of the image transfer optimized (ITO) HSF media (hereinafter “ITO/HSF media”);

FIG. 5 shows a cross section view of a first exemplary embodiment of inventive ITO/HSF media that may be provided in the inventive process embodiment shown in FIGS. 1 and 2A, and that is configured for selective deployment onto various target surfaces;

FIG. 6A shows a cross section view of a first alternate exemplary embodiment of the inventive ITO/HSF media shown in FIG. 5;

FIG. 6B shows a cross section view of a second alternate exemplary embodiment of the inventive ITO/HSF media shown in FIG. 5;

FIG. 7 shows a cross section view of a second exemplary embodiment of inventive ITO/HSF media that may be provided in the inventive process embodiment shown in FIGS. 1 and 2B, and that is configured for application to one or more intended surfaces in conjunction therewith;

FIG. 8A shows a cross section view of a first alternate exemplary embodiment of the inventive ITO/HSF media shown in FIG. 7;

FIG. 8B shows a cross section view of a second alternate exemplary embodiment of the inventive ITO/HSF media shown in FIG. 7;

FIG. 9 shows a schematic block diagram of a first exemplary embodiment of the inventive system for producing HSF/EI media in accordance with various embodiments of the inventive process of FIGS. 1 to 4;

FIG. 10 shows a schematic block diagram of an exemplary embodiment of the inventive system for on-demand selective production of HSF/EI media, implemented, by way of example, in a self-service user-operable system, such as a kiosk, vending machine, etc., utilizing an inventive system for producing HSF/EI media, such as one shown by way of example in FIG. 9; and

FIG. 11 shows a schematic block diagram of an exemplary embodiment of the inventive system for producing or selling HSF/EI media utilizing an e-Commerce platform that enables consumers to order and purchase pre-made and/or customized HSF/EI media, for example that may be produced on an “on-demand” basis, and shipped thereto.

### SUMMARY OF THE INVENTION

The various exemplary embodiments of the high surface friction (HSF) media of the present invention, that incorporate one or more graphical images embedded in an image transfer receptive target layer therein, positioned below at least one HSF material top surface layer, and the various exemplary embodiments of the system and method of production hereof, advantageously remedy and resolve the disadvantages and drawbacks of the previously known and proposed solutions for fabricating HSF materials having image(s) applied, or transferred, to their surfaces or surface layers.

In contrast to previously known solutions, the inventive system and method implement various embodiments of a novel production process that includes steps of embedding one or more predetermined pre-selected graphical images into an image transfer receptive (ITR) target layer of the novel HSF media, that is positioned below at least one image transfer compliant (ITC) HSF surface layer(s).

In summary, in at least one exemplary embodiment thereof, the inventive production process utilizes an image transfer system (such, as for example an dye sublimation system or equivalent thereof, that is operable, in accordance with one or more predetermined configurable image transfer protocols, to embed at least one image provided thereto, into a target image transfer receptive (ITR) material layer of predetermined image transfer optimized (ITO) HSF media provided to the image transfer system. ITO/HSF media, utilized in various embodiments of the present invention for embedding of at least one image therein, is preferably ITO media with at least one top ITC material layer having HSF properties, positioned over the ITR material layer. Optionally, the ITO/HSF media may also comprise at least one ITT material layer under the ITR material layer.

In one embodiment of the present invention, the ITO/HSF media may be pre-fabricated for selective future deployment (for example in an adhesive tape or sheeting format), and supplied to the image transfer system when the inventive image transfer process is initiated. Alternately, the ITO/HSF media may be fabricated as a layered material applied to a predetermined object or structural surface, prior to, or during, the performance of the novel image transfer process. In another embodiment of the present invention the ITO/HSF media may be produced on-demand, in conjunction with the performance of the image transfer process.

Advantageously, the techniques implemented in various embodiments of the present invention, not only improve the color accuracy, intensity and visible resolution of graphical image(s) embeddable into the inventive HSF media during production thereof, but also ensure that the embedded images(s) are protected from the surrounding environment, from contact with undesirable substances, and from external forces that would otherwise be capable of negatively impacting the graphical image(s).

The present invention also provides an exemplary embodiment of a system and method for on-demand selective production of HSF/EI media, implemented, by way of example, in a self-contained user-operable system (such as a kiosk, vending machine, etc.), and additionally provides an exemplary embodiment of a system and method for producing or selling HSF/EI media utilizing an e-Commerce platform, that enable consumers to order and purchase pre-made, and/or customized, HSF/EI media, for example that may be produced on an “on-demand” basis, and shipped thereto.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### DETAILED DESCRIPTION OF PREFERRED EMBODIMENTS

The high friction surface (HSF) media of the present invention, incorporating one or more graphical images embedded therein, and the system and method of production thereof, remedy the drawbacks of all previously known high surface friction materials having image(s) applied to their surfaces (e.g., through printing, painting, silk-screening, etc.). In stark contrast to previously known solutions, the inventive system and method are directed to various exemplary embodiments of novel production processes that involve embedding one or more predetermined user-selected graphical images into a sub-surface layer of the HSF media, rather than applying the images to the (typically coarse) outer surface(s) thereof.

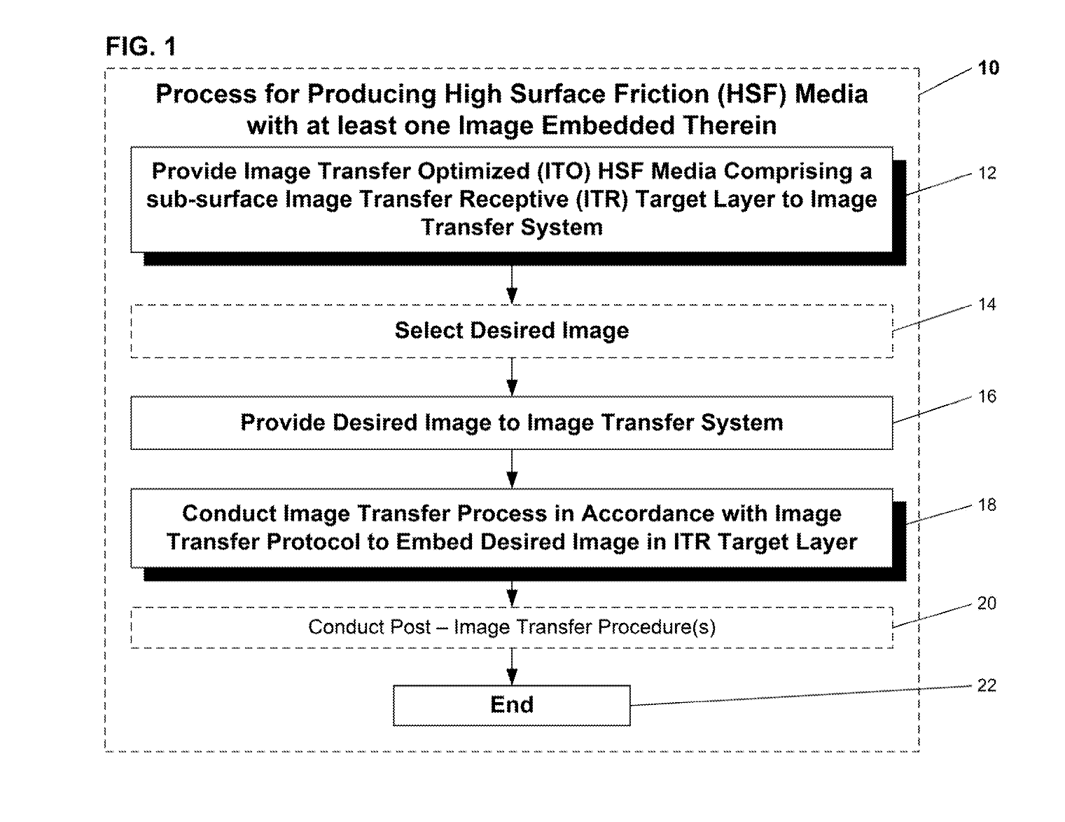

Referring now to FIG. 1, a first exemplary embodiment of the inventive process for producing HSF media with at least one image embedded therein (hereinafter “HSF/EI media”), is shown as a HSF/EI media production (HSF/EI_MP) process 10. The term “HSF” refers to non-slip, non-skid, improved grip, improved traction, abrasive, and/or equivalent properties of the surfaces of certain materials. These may have a coefficient of friction in a range selected as matter of design choice (for example being greater than 0.1). Typical HSF materials may have surfaces composed of abrasive “grit” elements held in place by a binding (or equivalent material), and may optionally be coated or covered with one or more thin protective material layers.

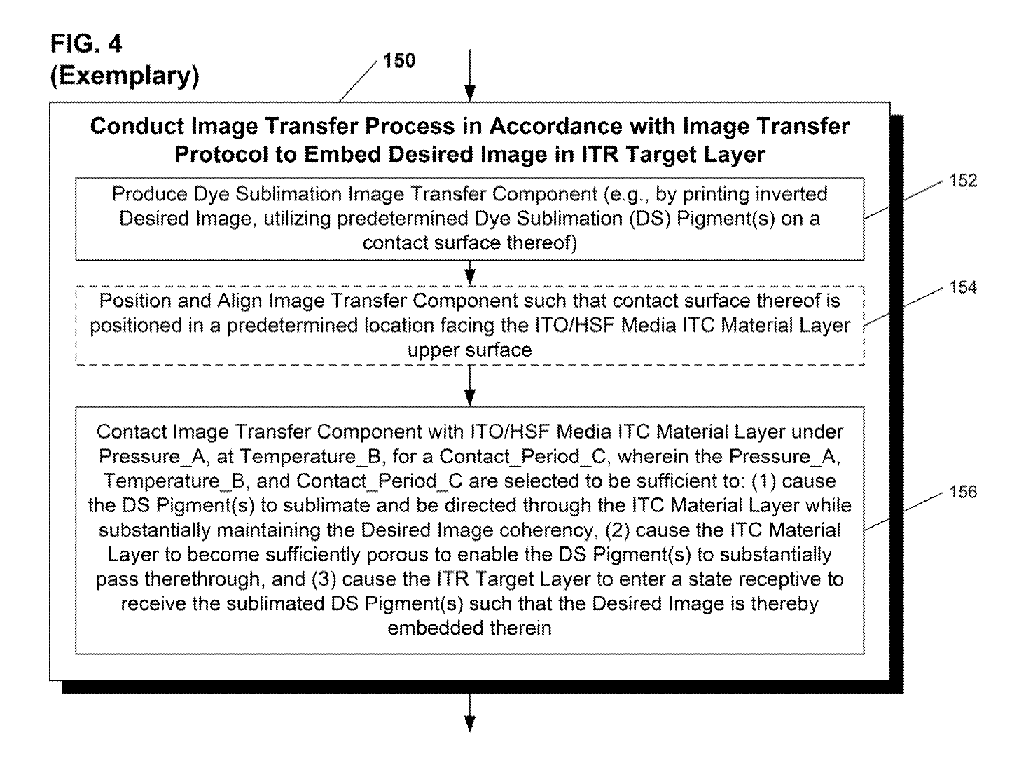

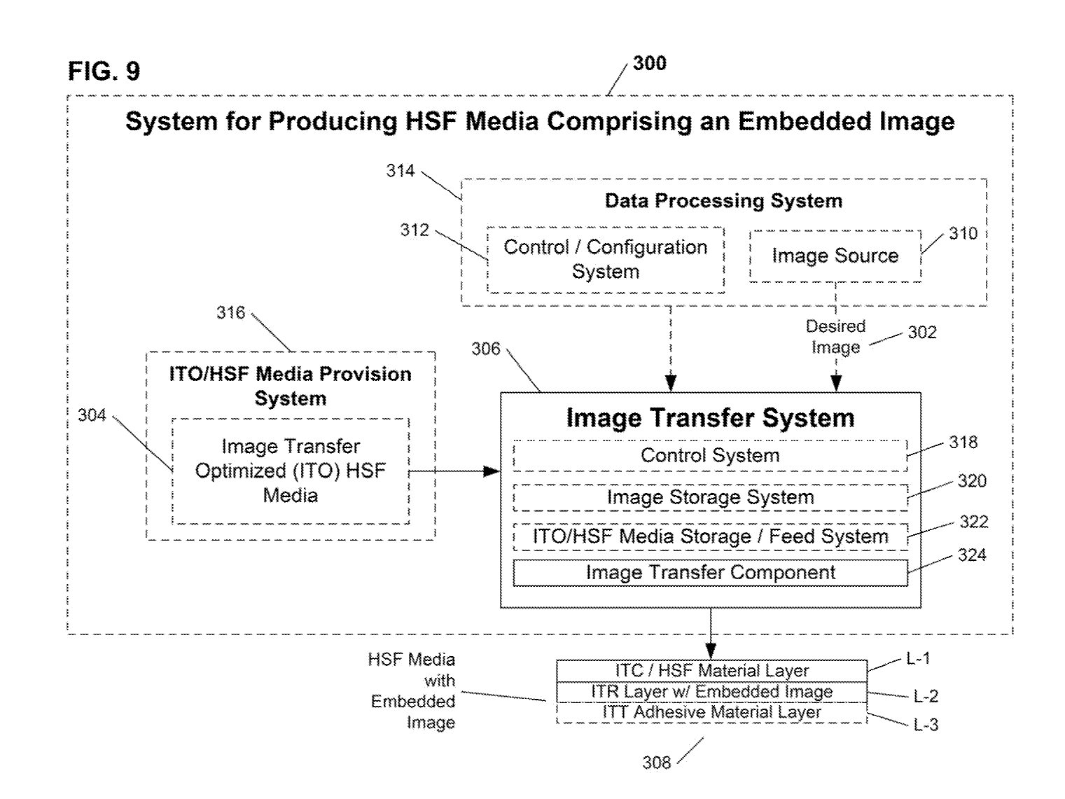

In accordance with the present invention, the HSF/EI_MP process 10 is at least partially implementable in a HSF/EI_MP system (such as, for example, the HSF/EI_MP system 300 of FIG. 9, described in greater detail below), that includes an image transfer system (such as, for example, the image transfer system 306 of FIG. 9) operable to perform an image transfer process (such as, by way of example, an exemplary image process of steps 152 to 156 of FIG. 4), utilizing one or more pre-selected and specially arranged pigments, to embed one or more images provided thereto into provided predetermined HSF media, and specifically into an HSF media target material layer that is positioned below at least one HSF surface layer of the HSF media. By way of example, any of a variety of pigments may be readily suitable for use with the inventive process 10, with each pigment serving as a physical material representative of a specific corresponding color, that is utilized by the image transfer system during operation thereof, to impart its corresponding color to a predetermined target material (for example by changing the pigment's state enabling it to enter the target material, such as though sublimation, and thereafter remain embedded, therein). Examples of suitable pigments include, but are not limited to, inks (dry, fluid, etc.), dyes, paints, stains, glazes, etc.

By way of example, an image transfer process that may be utilized in conjunction with the process 10, may involve: first preparing an image transfer component in the image transfer system (such as an image transfer component 324 of the image transfer system 306 of FIG. 9), to comprise a physical arrangement of at least one predetermined pigment, or equivalent, that visually corresponds to, and is representative of, at least one pre-selected image (for example, such as a graphical image stored in an electronic file readable by a data processing system 314 of FIG. 9), and then utilizing the image transfer component to transfer the at least one predetermined pigment arrangement into a target material, to substantially embed a representation of the at least one pre-selected image therein. Examples of image transfer processes include, but are not limited to, various dye sublimation processes, sublimation printing processes, and equivalents thereof.

Preferably, in various embodiments thereof, at least a portion of the steps of the inventive HSF/EI_MP process 10 may be automated in whole or in part, and may be conducted by, and/or under supervision of, a human operator, as a matter of design choice or convenience, without departing from the spirit of the present invention. Furthermore, in accordance with the present invention, the performance at least a portion of the steps of the HSF/EI_MP process 10, may be controlled or managed by at least one data processing system (such as a computer or equivalent (e.g., a process controller)) operable to execute various program instructions corresponding to applicable process 10 steps.

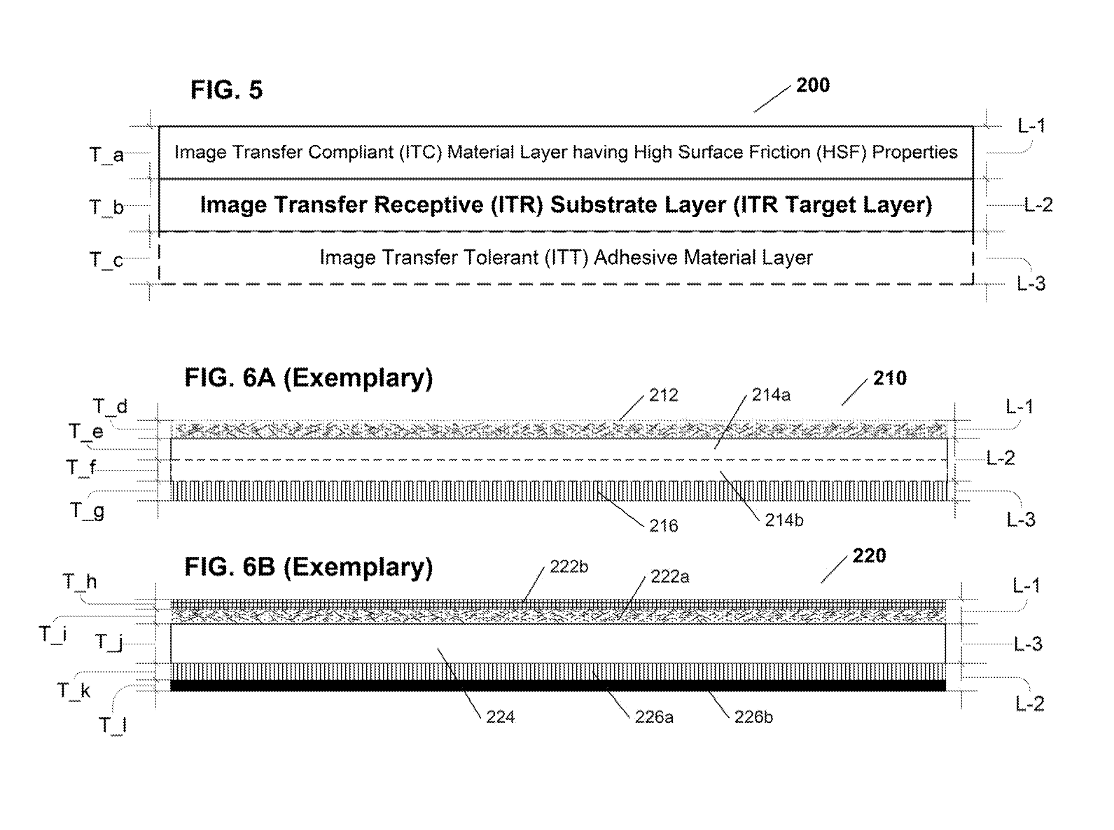

The HSF/EI_MP process 10 begins at a step 12, at which predetermined image transfer optimized (ITO) HSF media (hereinafter “ITO/HSF media”) (which may be, for example, any of the exemplary ITO/HSF media embodiments 200 to 280 of FIGS. 5 to 8A, respectively), comprising at least one top image transfer compliant (ITC) HSF material layer (hereinafter “ITC/HSF layer”), and a sub-surface image transfer receptive (ITR) material layer positioned thereunder, is provided to a predetermined image transfer system (e.g., such as, for example, the image transfer system 306 of FIG. 9), being utilized in conjunction with the performance of the process 10. The various material properties ITO, ITC, and ITR, referred to above, are described in greater detail below in connection with FIG. 5.

Referring now to FIG. 5, a first exemplary embodiment of the inventive ITO/HSF media configured for selective deployment onto various target surfaces, is shown as ITO/HSF media 200. Essentially, the inventive ITO/HSF media comprises an ITR material layer, and preferably includes at least one top substantially transparent ITC material layer, positioned over the ITR material layer, and, optionally, may also comprise one or more ITT material layers, positioned under the ITR layer. When subjected to an image transfer process, the ITR material layer enables the pigment arrangement, corresponding to the image being transferred, to substantially pass therethrough and to then become embedded in the ITR material layer. Advantageously, after the image transfer process is complete, the ITC material layer acts to protect the embedded image in the ITR material layer.

Preferably, in accordance with the present invention, the ITO/HSF media 200 includes at least two layers—a top layer L-1 comprising an ITC material layer with HSF properties, and a bottom layer L-2, comprising an ITR material “substrate” layer, serving as an ITR target layer for receiving at least one embedded image therein. It should be noted, that as used herein, the term “ITR” may be used to refer to a property, and/or to a possible state, of certain predetermined materials, that enables an image to be embedded in the ITR material, by facilitating the transfer (and subsequent retention) of a corresponding arrangement of at least one pigment, representative of the image into the ITR material (for example from an image transfer component, in connection with performance of an image transfer process).

In accordance with the present invention, an ITR material that may be selected for use as the layer L-2, is preferably operable to enter an ITR state during performance of certain applicable steps of an image transfer process, in accordance with a predetermined image transfer protocol (e.g., for example when the ITR material is subjected to heat and pressure within certain magnitude ranges for a predetermined period of time), such as for example as shown in FIG. 4, and as described below in connection therewith.

It should also be noted, that as used herein, the term “ITC” refers to a property, and/or to a possible state, of certain predetermined materials that enables arrangements of at least one pigment, representative of a corresponding image, to substantially pass through the ITC material, with minimal distortion or displacement thereof, and without being embedded therein, during performance of an image transfer process, such that the pigment arrangement can enter, and thereafter be embedded into, a sequentially positioned ITR material layer (e.g., such as the layer L-2).

In accordance with the present invention, an ITC material that may be selected for use as the layer L-1, is preferably operable to enter an ITC state during performance of certain applicable steps of an image transfer process, in accordance with a predetermined image transfer protocol (e.g., for example when the ITC material is subjected to heat and pressure within certain magnitude ranges for a predetermined period of time), such as for example as shown in FIG. 4, and as described below in connection therewith. Furthermore, each ITC material that may be utilized in accordance with the present invention as the layer L-1, is preferably selected or configured to be sufficiently transparent to enable an image embedded in the layer L-2 positioned thereunder, to be substantially visible therethrough with minimal distortion. Finally, in accordance with the present invention, it any ITC material selected for use in the layer L-1, must have a substantially higher melting point than that of the ITR material being utilized in conjunction therewith in the layer L-2.

In an alternate embodiment of the present invention, the ITO/HSF media 200 may also include an optional third layer L-3, comprising a material having image transfer tolerant (ITT) properties, and positioned below layer L-2, that is selected to provide predetermined adhesion functionality to the ITO/HSF media 200 (and to the HSF/EI media eventually produced therefrom). It should be noted, that as used herein, the term “ITT” may be used to refer to a property, and/or to a possible state, of certain predetermined materials, that may be optionally positioned proximally to an ITR material of layer L-2 (for example, to serve as an adhesive backing layer, etc.), that enables the ITT material to survive, without damage thereto, the conditions (e.g., temperature, pressure, duration, etc.) under which one or more applicable image transfer processes are conducted in accordance with a predetermined image transfer protocol (e.g., for example when the layer L-2 is heated and pressed sufficiently to cause it to enter an ITR state suitable for accepting an embedded image therein, the layer L-3 comprising an ITT material must be capable of tolerating the temperature and pressure to which it is subjected as a result of its contact with the layer L-2).

In an alternate embodiment of the present invention, the ITO/HSF media 200 may be produced, and utilized in conjunction with the process 10 of FIG. 1, to produce a HSF/EI media having only layers L-1 and L-2, with the layer L-3 being thereafter added as necessary.

In view of the exemplary descriptions of the terms ITC, ITR, and ITT provided above, it should thus be apparent to one skilled in the art that the term “ITO” as used herein, may be used to refer to inventive ITO/HSF media that comprises at least layers L-1 and L-2, with respective ITT and ITR material properties, and optionally also comprising the layer L-3 with ITT material properties.

In accordance with the present invention, as long as the specific provided ITO/HSF media 200, and the various layers L-1, L-2, (and when applicable, L-3) thereof, comprise the respective necessary material properties (i.e., ITC for layer L-1, ITR for layer L-2, and ITT for layer L-3), the specific materials composition, properties and characteristics of each layer (such as the respective thicknesses T_a to T_c thereof), may be readily selected or configured, as a matter of design choice, for example, in accordance with desired performance characteristics, the intended HSF/EI media 200 use, cost considerations, the type of image transfer system, and/or pigments being utilized, etc., without departing from the spirit of the invention. It should further be noted that the relative thicknesses T_a to T_c of each of the layers L-1 to L-3, are shown by example only, and are not shown to scale, and thus are not meant to be representative of, or to limit in any way, the possible relative thickness magnitude of each layer.

It should also be noted that in various embodiments of the present invention, one or more of each of the layers L-1 to L-3 of the ITO/HSF media 200 may each comprise one or more layers therein. For example, referring now to FIG. 6A, a first alternate exemplary embodiment of the inventive ITO/HSF media 200 of FIG. 5, is shown as ITO/HSF media 210, having the layer L-1 composed of a resin, polymer, or equivalent ITC material layer 212, comprising abrasive or grit elements sufficient to impart desired HSF properties to its surface, and also having the layer L-2 composed of two layers 214a, and 214b, of which only layer 214a must have ITR properties, while the layer 214b may be selected or configured to provide various other desirable properties or functionality to the ITO/HSF media 210. The ITO/HSF media 210, also includes the layer L-3 comprising a deactivated adhesive material 216, that may be readily and selectively activated when necessary, for example by moistening the material 216, or by otherwise triggering or activating its adhesive properties. It should further be noted that the relative thicknesses T_d to T_g of each of the material layers 212 to 216, are shown by example only, and are not shown to scale, and thus are not meant to be representative of, or to limit in any way, the possible relative thickness magnitude of each respective material layer.

Referring now to FIG. 6B, a second alternate exemplary embodiment of the inventive ITO/HSF media 200 of FIG. 5, is shown as ITO/HSF media 220, having the layer L-1 composed of a resin, polymer, or equivalent ITC material layer 222a, comprising abrasive or grit elements sufficient to impart desired HSF properties to its surface, covered with a protective ITC material surface layer 222b, and also having the layer L-2 composed of a material layer 224, such as for example a non-toxic PVC substrate having ITR properties. The ITO/HSF media 220, also includes the layer L-3 comprising an adhesive material layer 226a with ITT properties, and a removable protective support material layer 226b, also with ITT properties, such as, for example, brown paper or equivalent. It should further be noted that the relative thicknesses T_h to T_l of each of the material layers 222a to 226b, are shown by example only, and are not shown to scale, and thus are not meant to be representative of, or to limit in any way, the possible relative thickness magnitude of each respective material layer.

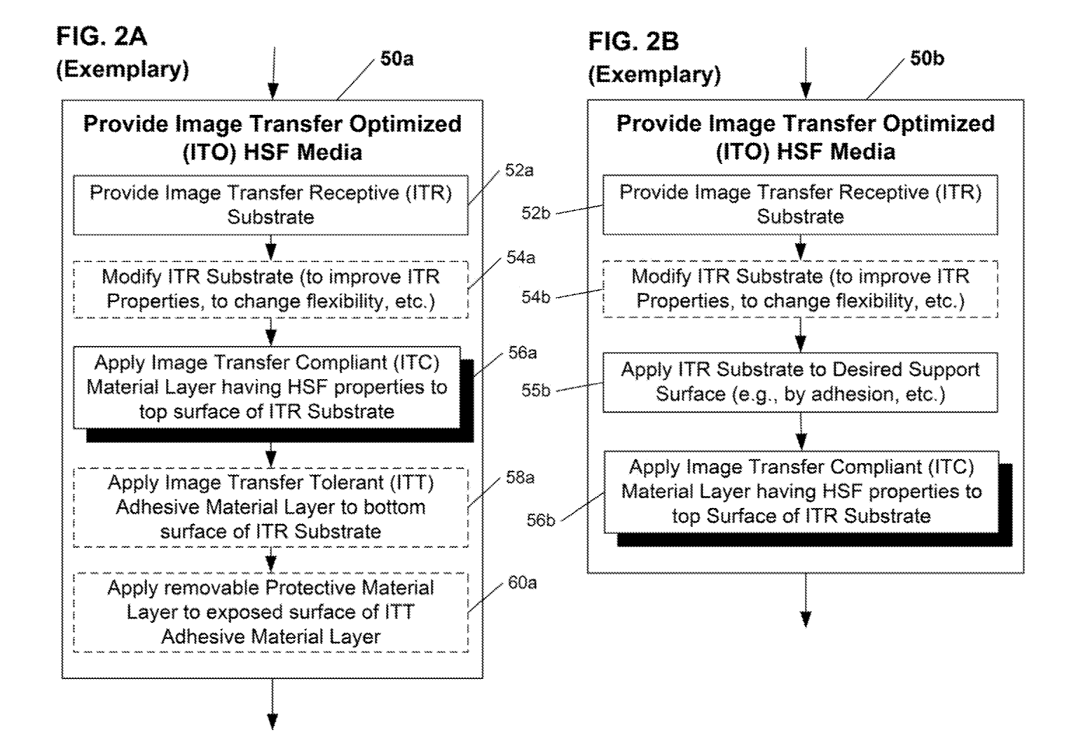

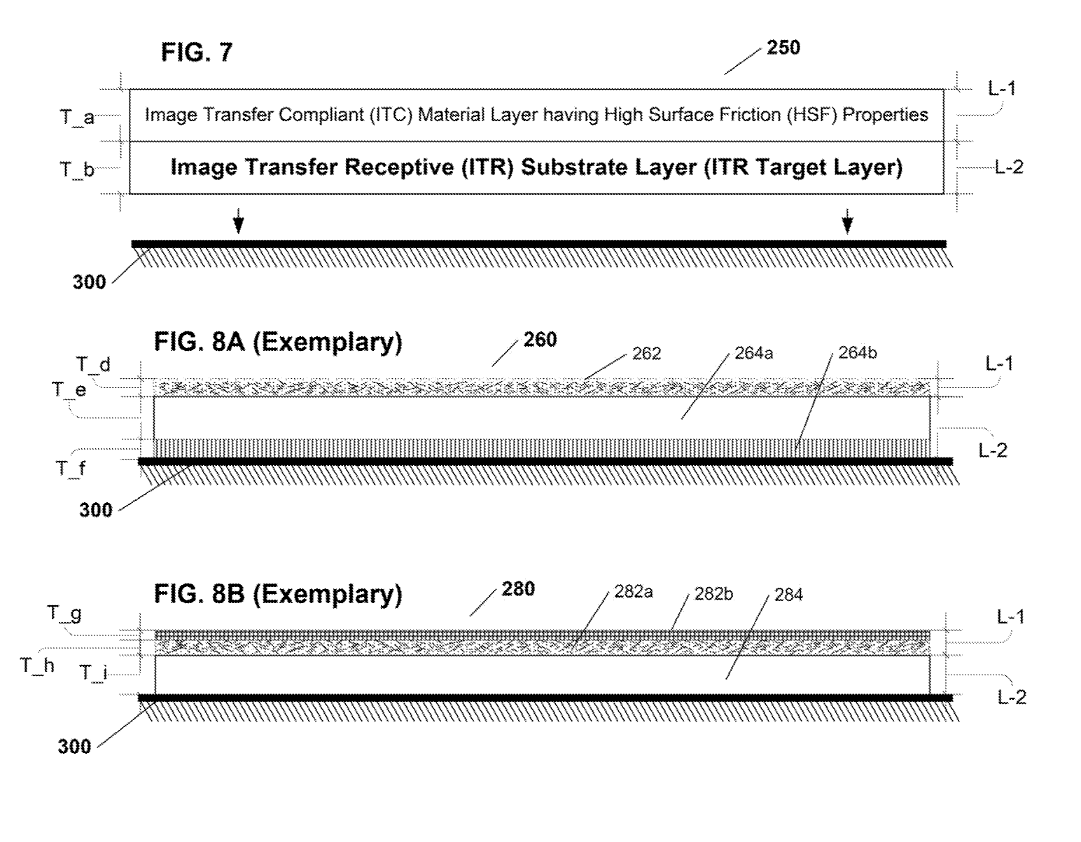

In an alternate embodiment of the present invention (shown, by way of example, in FIGS. 7 to 8B, and described in greater detail below in connection therewith), rather than being produced in selectively deployable configurations, such as the ITO/HSF media 200 to 220 of FIGS. 5 to 6B, the inventive ITO/HSF media may be fabricated as a layered material applied to a predetermined object or structural surface, prior to, or during, the process 10 of FIG. 1. Thus, for example, a product, such as a tile, a panel, a skateboard, or a running board, etc., may be fabricated with appropriate inventive ITO/HSF media applied thereto during the fabrication process, such that the product may be suitable for provision to the process 10 of FIG. 1 at step 12 thereof, for embedding at least one image in the applied ITO/HSF media. Alternately, the product on which the HSF/EI media is to be applied may be provided to the process 10 of FIG. 1, for initial application of the ITO/HSF media thereto at the step 12 (such as, by way of example, through the steps 52b to 56b of an alternate embodiment of step 12 of FIG. 1, shown as a sub-process 50b in FIG. 2B).

Referring now to FIG. 7, a second exemplary embodiment of the inventive ITO/HSF media configured for application to one or more intended target surface in conjunction with fabrication thereof, is shown as ITO/HSF media 250. Essentially, similarly to the ITO/HSF media 200 of FIG. 5, the inventive ITO/HSF media 250 preferably includes at least two layers—a top layer L-1 comprising an ITC material layer with HSF properties (preferably being similar or equivalent to the layer L-1 of FIG. 5), and a bottom layer L-2, comprising an ITR material “substrate” layer, serving as an ITR target layer for receiving at least one embedded image therein (preferably being similar or equivalent to the layer L-1 of FIG. 5, but also being configured for application (and subsequent attachment) to a target surface 300 (such as an object or product surface, or a structural surface—e.g., a floor, wall, door, roadway, etc.)).

In accordance with the present invention, as long as the specific provided ITO/HSF media 250, and the various layers L-1 and L-2 thereof, comprise the respective necessary material properties (i.e., ITC for layer L-1, and ITR and target surface 300 application capabilities for layer L-2), the specific materials composition, properties and characteristics of each layer (such as the respective thicknesses T_a to T_b thereof), may be readily selected or configured, for example, in accordance with desired performance characteristics, the intended HSF/EI media 250 use, cost considerations, the type of image transfer system, and/or pigments being utilized, etc., without departing from the spirit of the invention. It should further be noted, that the relative thicknesses T_a to T_b of each of the layers L-1 to L-2, are shown by example only, and are not shown to scale, and thus are not meant to be representative of, or to limit in any way, the possible relative thickness magnitude of each layer.

It should also be noted that in various embodiments of the present invention, one or more of each of the layers L-1 to L-2 of the ITO/HSF media 250 may each comprise one or more layers therein. For example, referring now to FIG. 8A, a first alternate exemplary embodiment of the inventive ITO/HSF media 250 of FIG. 7, is shown as ITO/HSF media 260, having the layer L-1 composed of a resin, polymer, or equivalent ITC material layer 262, comprising abrasive or grit elements sufficient to impart desired HSF properties to its surface, and also having the layer L-2 composed of two layers 264a, and 264b, of which only layer 264a must have ITR properties, while the layer 264b is preferably selected to enable the ITO/HSF media 260 to be securely applied, and attached to, the target surface material 300. It should further be noted that the relative thicknesses T_d to T_f of each of the material layers 262 to 264b, are shown by example only, and are not shown to scale, and thus are not meant to be representative of, or to limit in any way, the possible relative thickness magnitude of each respective material layer.

Referring now to FIG. 8B, a second alternate exemplary embodiment of the inventive ITO/HSF media 250 of FIG. 7, is shown as ITO/HSF media 280, having the layer L-1 composed of a resin, polymer, or equivalent ITC material layer 282a, comprising abrasive or grit elements sufficient to impart desired HSF properties to its surface, covered with a protective ITC material surface layer 282b, and also having the layer L-2 composed of a material layer 284, such as for example a non-toxic PVC substrate having ITR properties but that is also configured for application and secure attachment to the target surface 300. It should further be noted that the relative thicknesses T_g to T_i of each of the material layers 282a to 284, are shown by example only, and are not shown to scale, and thus are not meant to be representative of, or to limit in any way, the possible relative thickness magnitude of each respective material layer.

Returning now to FIG. 1, in at least one embodiment of the present invention, pre-configured ITO/HSF media, that has been previously prepared for accepting an image transfer, may be readily provided to the image transfer system at the step 12. Examples of such provided ITO/HSF media include, but are not limited to:
(1) Pre-fabricated ITO/HSF media that is subsequently deployable onto one or more target surfaces (e.g., such as illustrated by various inventive embodiments of ITO/HSF media shown in FIGS. 5 to 6B, by way of example, as deployable ITO/HSF media 200, 210, 220, respectively, and are described in greater detail above in connection therewith), and/or
(2) ITO/HSF media that has previously been applied to a target object, or to a target structural surface (e.g., such as illustrated by various inventive embodiments of ITO/HSF media shown in FIGS. 7 to 8B, by way of example, as applied ITO/HSF media 250, 260, 280, respectively, and are described in greater detail above in connection therewith).

In at least one alternate embodiment of the process 10, step 12 comprises various sub-process steps of configuring and producing the ITO/HSF media, during the performance of the process 10, for utilization thereof at subsequent process 10 steps, such as may be implemented, by way of example, as sub-processes 50a and 50b, of FIGS. 2A, and 2B, respectively.

Referring first to FIG. 2A, a process flow diagram of a first exemplary alternate embodiment of the step 12 of process 10 of FIG. 1, is shown as a sub-process 50a for providing ITO/HSF media to the image transfer system by fabrication thereof in a selectively deployable configuration (e.g., such that the HSF/EI media produced by the process 10 can later be applied to one or more desired surfaces). The sub-process 50a begins at a step 52a, at which an ITR material substrate (such as the layer L-2 of FIGS. 5 to 6B) is provided. Then, at an optional step 54a, the ITR substrate may be modified (to improve ITR properties thereof, to change flexibility, to strengthen, to improve color stability, etc.) by application thereto of one or more “modifiers”, selected from a group that includes, but that is not limited to, lubricants, stabilizers, plasticizers, color or phosphorescent or luminescent pigments, and or one or more other suitable substances. At a step 56a, an ITC material layer having HSF properties (such as the layer L-1 of FIGS. 5 to 6B) is applied to the top surface of the ITR substrate, and, at an optional step 58a, an ITT adhesive material layer (such as the layer L-3 of FIGS. 5 to 6B), may be applied to the bottom surface of ITR substrate, and at an optional step 60a, a removable protective material layer (such as, for example, the protective layer 226b of FIG. 6B) may then be applied to the exposed surface of the ITT adhesive material layer applied at step 58a.

Referring second to FIG. 2B, a process flow diagram of a second exemplary alternate embodiment of the step 12 of process 10 of FIG. 1, is shown as a sub-process 50b for providing ITO/HSF media to the image transfer system by application thereof to a desired target surface of an object or of a structure (e.g., such that the HSF/EI media is produced and applied to the desired target surface during performance of the process 10). The sub-process 50b begins at a step 52b, at which an ITR material substrate (such as the layer L-2 of FIGS. 7 to 8B) is provided. Then, at an optional step 54b, the ITR substrate may be modified (to improve ITR properties thereof, to change flexibility, to strengthen, to improve color stability, etc.) by application thereto of one or more “modifiers”, selected from a group that includes, but that is not limited to, lubricants, stabilizers, plasticizers, color or phosphorescent or luminescent pigments, and or one or more other suitable substances. At a step 55b, the ITR substrate is applied to the desired support or target surface (for example by adhesion, depositing, fusion, or by any suitable equivalent attachment or coating process). At a step 56b, an ITC material layer having HSF properties (such as the layer L-1 of FIGS. 7 to 8B) is applied to the top surface of the ITR substrate.

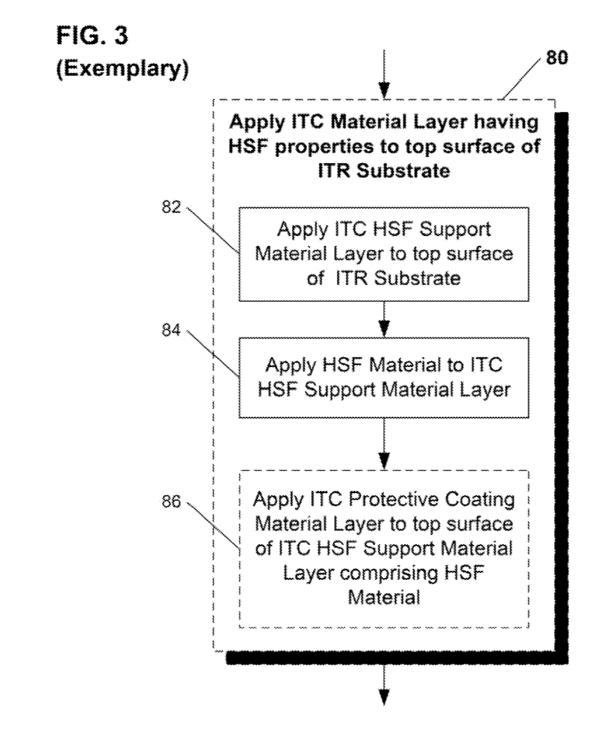

In an alternate embodiment of the process 10, the step 56a of FIG. 2A, and/or the step 56b of the FIG. 2B, may each comprise sub-process steps of applying the ITC material layer having HSF properties to the top surface of the ITR substrate, such as may be implemented, by way of example, as a sub-processes 80 of FIG. 3.

Referring now to FIG. 3, a process flow diagram of an exemplary alternate embodiment of the step 56a of the sub-process 50a of FIG. 2A, and/or of the step 56b of the sub-process 50b of FIG. 2B, is shown as the sub-process 80 for applying the ITC material layer having HSF properties to the top surface of the ITR substrate. The sub-process 80 begins at a step 82, at which an ITC HSF support material layer, configured to receive HSF material (such as granules, grit, crystals, or equivalents thereof) and to retain the HSF materials therein, is applied to top surface of ITR substrate. At a step 84, predetermined HSF material is applied to, and embedded in, the ITC HSF support material layer.

While specific type or composition of the HSF material utilized at this step may be selected as a matter of design choice, without departing from the spirit of the invention, it is preferable to select HSF material that is capable of being synergistically enhanced in conjunction with performance of other subsequent steps of the inventive process 10 of FIG. 1. For example, if a heat and pressure based image transfer process is utilized during the process 10 to embed the desired image in the ITO/HSF media, it may be advantageous to utilize HSF material that is likely to undergo “friation” when subjected to heat and pressure, such as aluminum oxide grit. When undergoing friation, aluminum oxide splinters and forms smaller fragments, thus creating a plurality of new sharp edges in the HSF material surface. Moreover, a friated HSF surface material continues to improve its surface friction properties with continued use, while becoming more durable than non-friated version of the same material. Finally, at an optional step 86, an ITC protective coating material layer (such as, for example, a protective resin coating) may be applied to the top surface of the ITC HSF support material layer comprising HSF material, that has been produced at the steps 82 and 84.

Returning now to FIG. 1, at an optional step 14, a desired image (or images) may be selected by a process operator, or user, for provision to the image transfer system, or the image or images may be selected automatically from a sequential electronic list previously provided to a data processing system controlling the process 10 operation. Additionally, the step 14 would be performed, by way of example, when the process 10 is utilized to produce custom HSF/EI media incorporating at least one desired image selected by a process 10 operator or a user. However, in an alternate embodiment of the present invention, in which the process 10 is configured for repetitive or mass-production of HSF/EI media incorporating a predetermined image, the optional step 14 may be avoided.

At a step 16, the desired image (or images) is provided to the image transfer system, and, at a step 18, the image transfer process is conducted in accordance with a predetermined image transfer protocol, to embed the desired image(s) in the ITR target layer of the ITO/HSF media. An image transfer protocol is preferably a set of parameters (and, where applicable, parameter ranges) and a set of operating conditions for conducting a predetermined image transfer process utilizing a predetermined image transfer system, that is configured to achieve optimal performance thereof, wherein the parameters and operating conditions have preferably been selected and configured based, at least in part, on one or more of the following: (1) the type or configuration of the image transfer system, and of the corresponding image transfer process, (2) the type and/or color of the pigment(s) being used to represent the desired image(s) intended for transfer, and (3) the properties or characteristics of the ITO/HSF media (and the various material layers thereof, being utilized).

In an exemplary alternate embodiment of the process 10, in which the image transfer process being substantially corresponds to dye sublimation, the step 18 may comprise sub-process steps of conducting a dye sublimation-type image transfer process in accordance with a predetermined image transfer protocol, to embed the desired image(s) in the ITR target layer of the ITO/HSF media, such as may be implemented, by way of example, as a sub-process 150 of FIG. 4.

Referring now to FIG. 4, a process flow diagram of an exemplary alternate embodiment of the step 18 of the process 10 of FIG. 1, is shown as the sub-process 150 for conducting the image transfer process in accordance with a predetermined image transfer protocol, to embed the desired image(s) in the ITR target layer of the ITO/HSF media utilizing a dye sublimation type technique. The sub-process 150 begins at a step 152, at which a dye sublimation (DS) image transfer component, having a contact surface, is produced by a DS image transfer system (e.g., by printing an inverted version of the desired image(s), utilizing predetermined dye sublimation (DS) pigment(s) on the contact surface thereof)

Depending on the type of the DS image transfer system being utilized to perform the sub-process 150 (e.g., a clamshell type press, or a roller-based system, the DS image transfer component may be configured as a flat sheet or plate, or, alternately it may be applied to an outer surface of a roller component.

If necessary, an optional step 154 may then be performed to position and align the DS image transfer component, such that contact surface thereof is positioned in a predetermined location facing the portion of the ITO/HSF media ITC material layer upper surface through which the desired image must be transferred to the ITR target layer underneath. Performance of the optional step 154 may be advantageous when the sub-process 150 is being utilized to embed at least one image into a ITO/HSF media that has been previously applied to a target object or structure surface that is unwieldy for use with a conventional DS image transfer system.

At a step 156, the image transfer component is brought into contact with ITO/HSF media ITC material layer in accordance with the predetermined image transfer protocol (i.e., under a pressure_A, at temperature_B, for a contact_period_C, wherein the values of the pressure_A, the temperature_B, and the contact_period_C are selected to be sufficient to:
(1) cause the DS pigment(s) to sublimate (i.e. to achieve a substantially gaseous state), and to be directed through the top ITC material layer, while substantially maintaining the desired image coherency,
(2) cause the ITC material layer to become sufficiently porous to enable the DS pigment(s) to substantially pass therethrough without substantial loss of coherency, and
(3) cause the ITR target layer to enter a state receptive to passage of the sublimated DS pigment(s) therein such that the desired image is thereby embedded in the ITR layer.

Returning now to FIG. 1, the process 10, may proceed to an optional step 20, of conducting one or more post-image transfer procedures (such as, for example, allowing the produced HSF/EI media to cool, or to cure, or otherwise process the HSF/EI media, before the process 10 ends at a step 22. Optionally, in an alternate embodiment of the present invention, instead of ending at the step 22, the process 10 may be repeated, selectively or automatically to produce one or more additional sets of HSF/EI media utilizing the same or another at least one desired image.

Referring now to FIG. 9, a first exemplary embodiment of an inventive system for producing HSF/EI media, utilizing ITO/HSF media, such as ITO/HSF media of FIGS. 5 to 8B, is shown as a HSF/EI Media Production (HSF/EI_MP) system 300, that may be operated to perform at least a substantial portion of the process 10 of FIG. 1 as well as the exemplary sub-process 150 of FIG. 4. At the outset, it should be noted that the HSF/EI_MP system 300 and various components thereof, are described below with references to various dye sublimation—related technologies and techniques by way of example only—the system and method of the present invention is readily operable for implementation in virtually any form of a pigment-based image transfer system or equivalent, capable of working with ITO media comprising at least ITC and ITR materials.

The HSF/EI_MP system 300 is preferably based around an HSF media-capable image transfer system 306 (which may be, for example, a dye sublimation printing system or equivalent), comprising an image transfer component 324, that may includes a heat/pressure system (e.g., such as a calendar, roller, clamshell or other configuration), operable to embed images into predetermined ITO/HSF media 304 that is provided thereto by the system operator directly, or, alternately that is provided by an optional internal ITO/HSF media storage/feed system 322, or, that is provided thereto from an optional external ITO/HSF media provision system 316, to produce desired HSF/EI media 308, having layers L-1 and L-2, and optionally, L-3.

It should be noted, that when the image transfer system 3-6 is dye sublimation—based, in accordance with the present invention, favorable HSF/EI media production results have been achieved when the layer L-1 material composition includes either a very light (e.g., substantially white or off-white) pigment, or a phosphorescent or luminescent pigment, such (e.g., such as based on Zinc Sulphide). By way of example only, and without departing from the spirit of the present invention, the ITO/HSF media 304 may be sized, shaped, and configured in the form of individual sheets, tape rolls, sheet rolls, and the like.

The image transfer system 306 may optionally include one or more optional components, such as a control system 318 operable to control the operation thereof, an internal image storage system 320 operable to store one or more desired images for transfer into ITO/HSF media, and the above-noted internal ITO/HSF media storage/feed system 322.

The system 300 may also include an optional data processing system 314 (such as a computer or a network of computers equipped with appropriate software) for controlling or managing the operation of the entire system 300, and/or of various components thereof. The system 300 may also be optionally provided with a control or configuration system 312 (which may alternately be implemented as a sub-component, or as a feature set, of the data processing system 314, or of the image transfer system 306), for controlling or configuring the operation of the system 300, for adjusting the image transfer process protocol (i.e., temperature, pressure, process time value ranges, etc.), and for other purposes.

The desired image(s) utilized to generate the desired image 302, may be obtained from one or more data storage components of the data processing system 314 (such as from a computer hard drive or equivalent), or may otherwise be obtained from an optional image source 310, such as from a scanner, camera, or other data input (e.g., a memory card or drive connected to the data processing system 314, or directly to the image transfer system 306). Optionally, the data processing system 314 may include additional features, such as various image processing or optimization functions operable to adjust image transfer protocol parameters utilized by the image transfer system 306, based on the characteristics or properties of the image 302, and/or based on the characteristics or properties of the particular type of ITO/HSF media 304 being utilized.

Advantageously, the system 300 may operate as described above, but may also be supplemented with additional component(s) for optional post-processing of the desired HSF/EI media 308.

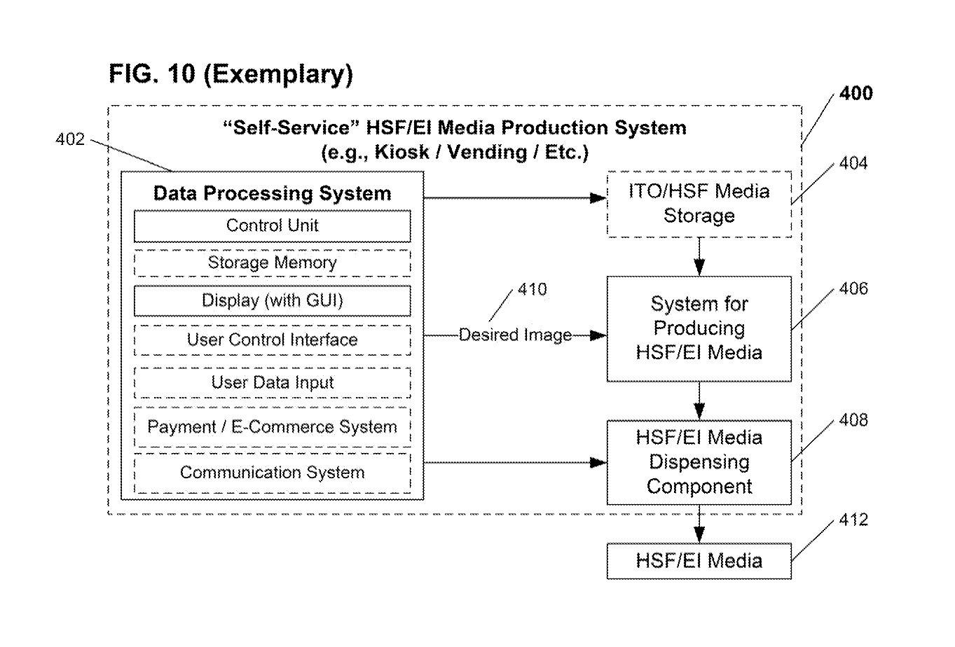

Referring now to FIG. 10, an exemplary embodiment of the inventive system for on-demand selective production of HSF/EI media is shown, implemented, by way of example, in a “self-service” user-operable HSF/EI media production (HSF/EI_MP) system 400, that is operable by a user thereof, to produce HSF/EI media 412 that comprises at least one user-selected desired image 410. In various alternate embodiments thereof, the self-service HSF/EI_MP system 400 may be readily implemented as a kiosk, vending machine, etc., as a matter of design choice without departing from the spirit of the invention.

Advantageously, the HSF/EI_MP system 400 includes a sub-system 406 (such as, for example, the HSF/EI_MP system 300 of FIG. 9), for producing HSF/EI media 412, an optional ITO/HSF media storage component 404, and a HSF/EI media dispensing component 408, operable to dispense the HSF/EI media fabricated by the HSF/EI_MP system 406. The HSF/EI_MP system 400 also includes a data processing system 402, having plural components operable to enable users thereof to interact with the HSF/EI_MP system 400, to control its operation, to purchase preconfigured, or custom-designed, HSF/EI media products, and to perform other related tasks.

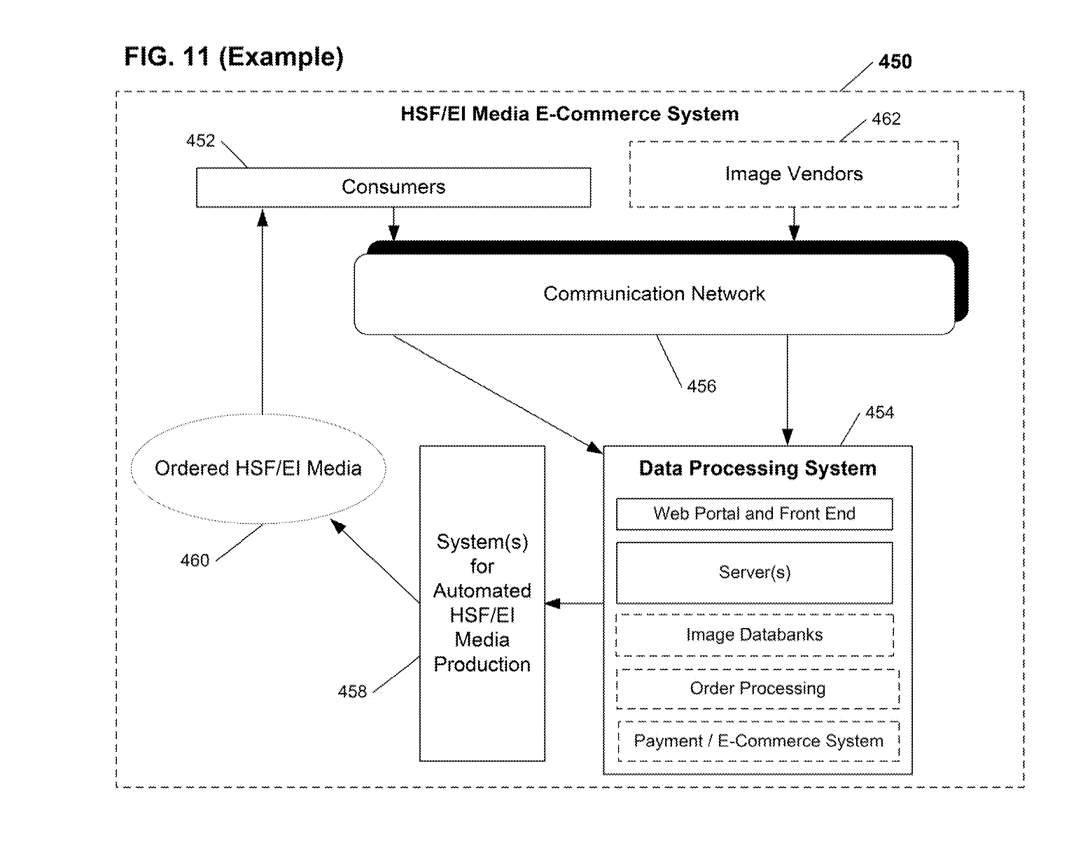

Referring now to FIG. 11, an exemplary embodiment of the inventive system for producing or selling HSF/EI media utilizing an e-Commerce platform that enables consumers to order and purchase pre-made, and/or customized HSF/EI media, is shown as a HSF/EI media e-Commerce system 450, operable to provide an e-Commerce platform that enables consumers 452 to order pre-made and/or customized HSF/EI media 460 from a web portal front end of a data processing system 454, over at least one communication network 456 (such as the Internet), that may be produced on an “on-demand” basis (for example, utilizing at least one automated HSF/EI media production system 458). The images used in HSF/EI media 460 production may be provided by an owner/operator of a HSF/EI media e-Commerce system 450 (and supplied through the data processing system 454), or submitted by consumers 452, and/or optionally supplied or sold by one or more image vendor(s) 462.

Thus, while there have been shown and described and pointed out fundamental novel features of the inventive apparatus as applied to preferred embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

I claim:

1. A process for producing a material having at least one predetermined image embedded therein, comprising the steps of:
(a) providing a substantially flat media including a plurality of material layers, said plural layers including:
at least one top surface material layer having a coefficient of friction greater than 0.3, and a first predefined material composition being configured to enable said at least one top surface material layer to enter into, and to remain in, an image transfer compliant state when subjected to at least one first predetermined image transfer condition, and
an image target material layer positioned below said at least one top surface material layer, said image target material layer having a second predefined material composition being selected and configured to enable said image target material layer to enter into, and to remain in, an image transfer receptive state when subjected to at least one second predetermined image transfer condition;
(b) generating an image transfer component having a transfer surface including a predetermined pattern of at least one pigment corresponding to, and being representative of, the at least one predetermined image,
(c) continually subjecting said at least one top surface material layer to said at least one first predetermined image transfer condition, and subjecting said image target material layer to said at least one second predetermined image transfer condition;
(d) substantially simultaneously with performance of said step (c), contacting said transfer surface with said at least one top surface material layer at a predetermined pressure sufficient to cause said predetermined pattern of at least one pigment to substantially pass through said at least one top surface material layer, and to enter into said image target material layer; and
(e) terminating the performance of said step (c), thereby resulting in the predetermined pattern of at least one pigment, representative of the at least one predetermined image to become embedded in said image target material.

2. A method for producing a material having at least one predetermined image embedded therein, comprising the steps of:
(a) providing a generally flat media, having at least one upper surface layer having a coefficient of friction greater than 0.3, and a lower surface layer;
(b) generating a predetermined embeddable imaging material pattern corresponding to the at least one predetermined image, and
(c) causing, by application of a predefined image transfer process thereto, said at least one upper surface layer to allow said predetermined imaging material pattern to substantially pass therethrough, and causing, by application of said predefined image transfer process thereto, said lower surface layer to capture and retain said predetermined imaging material pattern, thereby embedding a representation of the at least one predetermined image therein.

3. An apparatus operable to produce a material having at least one predetermined image embedded therein, comprising:
means for providing a generally flat media, having at least one upper surface layer having a coefficient of friction greater than 0.3, and a lower surface layer; and
an image transfer system operable to:
generate a predetermined embeddable imaging material pattern, corresponding to the at least one predetermined image, and
apply a predefined image transfer process to said flat media, said predefined image transfer process being configured to cause said at least one upper surface layer to allow said predetermined imaging material pattern to substantially pass therethrough, and being configured to cause said lower surface layer to capture and retain said predetermined imaging material pattern, thereby embedding a representation of the at least one predetermined image therein.
